(19) United States
(12) Patent Application Publication
(10) Pub. No.: US 2012/0159795 A1
(43) Pub. Date: Jun. 28, 2012

(54) ELECTRIC HEAD SHAVER WITH ERGONOMIC HANDLE

(76) Inventor: Harry A. Walmsley, Bonita Springs, FL (US)

(21) Appl. No.: 12/978,769

(22) Filed: Dec. 27, 2010

(51) Int. Cl. B26B 19/38

(52) U.S. Cl. 30/526

(57) ABSTRACT

An electric shaver (1) having an ergonomic handle (2) with a proximal end (3) and a distal end (4) having one or more conventional electric blades (5) located thereon. The length of the ergonomic handle is preferably equal to the average user's finger length, thereby allowing a user to hold the electric shaver horizontal to his fingers while resting the proximal end of the ergonomic handle against the palm of the hand. The ergonomic handle may also be rounded so that it rests directly in the user's hand. One or more finger grooves (6) and/or rubber strips (8) may also be located on the ergonomic handle to provide a user with a firm grip on the ergonomic handle and thus provide greater control of the electric shaver.

### BACKGROUND OF THE INVENTION

This invention relates to electric shavers used for shaving the face and the head, more particularly, an electric head shaver having a specially shaped ergonomic handle that provides a user with better control of the electric shaver while the user is shaving his head.

In recent time it has become more fashionable for men to shave their heads. Conventional shaving devices available to users include conventional straight razors, safety razors and electric shavers. However, these conventional devices, especially with regard to electric shavers, are not suited for shaving the head. Specifically, electric shavers are awkward to hold especially when shaving areas of the head that are out of the line of sight of the user. Shaving the head requires that a user be able to feel the surface being shaved in order to obtain a close and even shave. Conventional electric shavers do not meet these needs because of the awkwardness of shaving certain areas of the head, especially the back of the head.

There has been advances in the design of conventional shaving razors making conventional straight razors more convenient and safer to use when shaving the head. However, conventional electric shavers are designed primarily for shaving the face and thus have longer handles and are not ergonomically designed to accommodate shaving the head.

Therefore, a need exists for an electric shaver having an ergonomic handle that allows a user to firmly grip the electric shaver while shaving the user's head, thereby allowing the user to obtain a close and even shave on his head.

| Patent/Serial No. | Inventor | Issue/Publication Date |
|---|---|---|
| D603,096 | Greene | Oct. 27, 2009 |
| 7,140,115 | Greene | Nov. 28, 2006 |
| D520,681 | Beedham | May 09, 2006 |
| D500,889 | Greene | Jan. 11, 2005 |
| D446351 | Greene | Aug. 07, 2001 |
| 6,112,421 | Greene | Sep. 05, 2000 |
| D426,918 | Greene | Jun. 20, 2000 |
| 6,018,877 | Greene | Feb. 01, 2000 |

### SUMMARY OF THE INVENTION

The primary object of the present invention is to provide an electric head shaver having an ergonomic handle that allows a user to firmly grip the electric shaver while shaving the user's head.

A further object of the present invention is to provide an electric head shaver having an ergonomic handle that allows a user to obtain a close and even shave on his head.

The present invention fulfills the above and other objects by providing an electric head shaver having an ergonomic handle with a proximal end and a distal end having one or more conventional electric blades located thereon. The length of the ergonomic handle is considerably shorter than conventional electric shaver handles, which are designed to be gripped by a user so the handle is perpendicular to the user's fingers. A perpendicular grip allows a user to easily shave his face but does not allow a user to easily shave awkward areas such as the back of the head or the. The length of the ergonomic handle is preferably equal to the length of an index finger of the user, thereby allowing a user to hold the electric shaver horizontal to his fingers while resting the proximal end of the ergonomic handle against the palm of the hand. The shortened length of the ergonomic handle allows a user to keep firm control of the up and down and back and forth motion of the electric shaver with the user's fingers while the user's palm controls the pressure between the blades of the electric shaver and the skin. In an alternative embodiment of the ergonomic handle, the ergonomic handle is rounded so that it rests directly in the user's hand. One or more grooves may also be located on the ergonomic handle. A user may place his fingers in the grooves to obtain a firm grip on the ergonomic handle and thus have greater control of the electric shaver.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a front side view of an electric head shaver with ergonomic handle of the present invention;

FIG. 2 is a left side view of the electric head shaver with ergonomic handle of the present invention;

FIG. 3 is a right side view of the electric head shaver with ergonomic handle of the present invention;

FIG. 4 is a rear side view of the electric head shaver with ergonomic handle of the present invention;

FIG. 5 is a perspective view showing the top rear side of the electric head shaver with ergonomic handle of the present invention;

FIG. 6 is a bottom view of the electric head shaver with ergonomic handle of the present invention;

FIG. 7 is a side view of the electric head shaver with ergonomic handle of the present invention, in which the handle is substantially round; and

FIG. 8 is a bottom view of the electric head shaver with ergonomic handle of the present invention, in which the handle is substantially round.

### DESCRIPTION OF THE PREFERRED EMBODIMENTS

For purposes of describing the preferred embodiment, the terminology used in reference to the numbered components in the drawings is as follows:

```
  1. electric head shaver
  2. ergonomic handle
  3. proximal end
  4. distal end
  5. electric blade
  6. finger groove
  7. gripping means
  8. rubber strip
  9. electrical socket
10. length
```

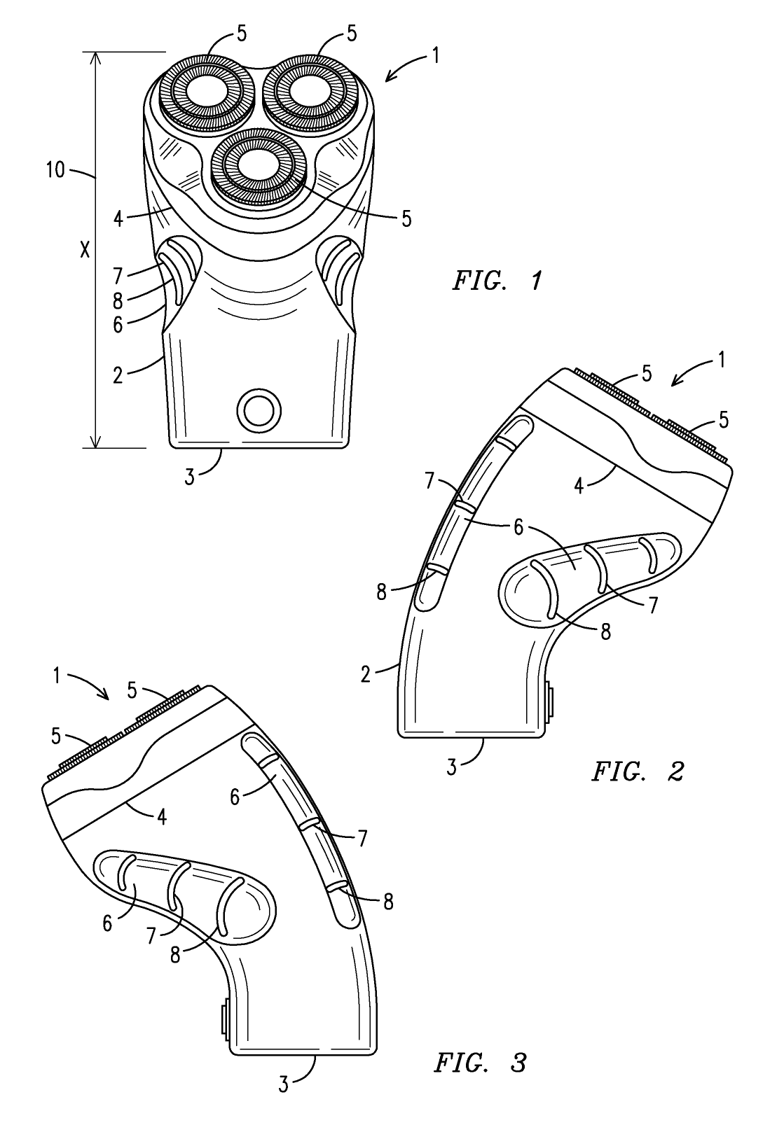

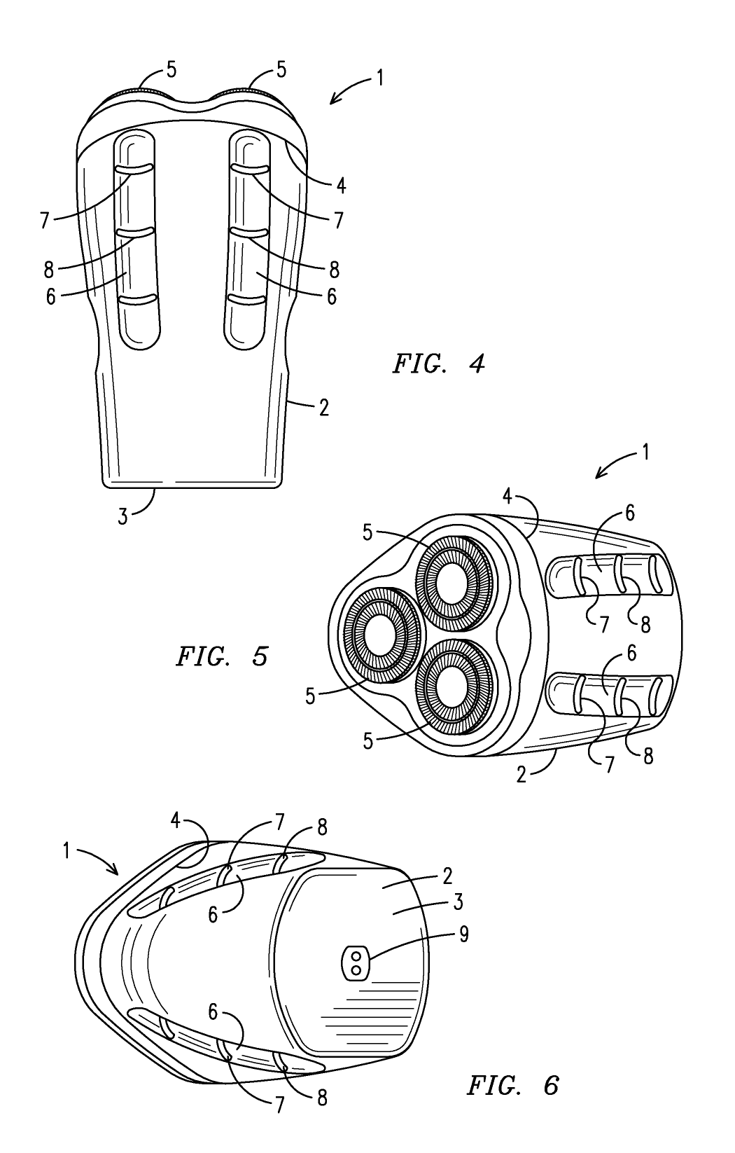

With reference to FIGS. 1-6, a front side view, a left side view, a right side view, a rear side view, a perspective view and a bottom view, respectively, of an electric head shaver 1 having an ergonomic handle 2 of the present invention are shown. The ergonomic handle 2 has a proximal end 3 and a distal end 4 having one or more conventional electric blades 5 located thereon. The length 10 of the ergonomic handle 2 is considerably shorter than conventional electric shaver handles. The length 10 represented by X where X is substantially equal to the average length of a human index finger or between a range of 1-4 inches, thereby allowing a user to hold the electric shaver 1 horizontal to his fingers while resting the proximal end 3 of the ergonomic handle 2 against the palm of the user's hand. The shortened length of the ergonomic handle 2 allows a user to maintain firm control of the up and down and back and forth motion of the electric shaver 1 with the user's fingers while the user's palm controls the pressure between the blades 5 of the electric shaver 1 and the user's skin. One or more finger grooves 6 may also be located on the ergonomic handle 2. A user may place his fingers in the finger grooves 6 to obtain a firm grip on the ergonomic handle 2 and thus have greater control of the electric shaver 1. A gripping means 7, such as rubber strips 8, are located on the ergonomic handle 2 to prevent the ergonomic handle from slipping out of a user's hand. An additional benefit of the ergonomic handle 2 is that it may be held like a conventional electric shaver when shaving the face. An electrical socket 9 is preferably located on the proximal end 3 of the ergonomic handle 2. The electrical socket 9 may be used in conjunction with an electric cord or a charging base to power the electric shaver 1.

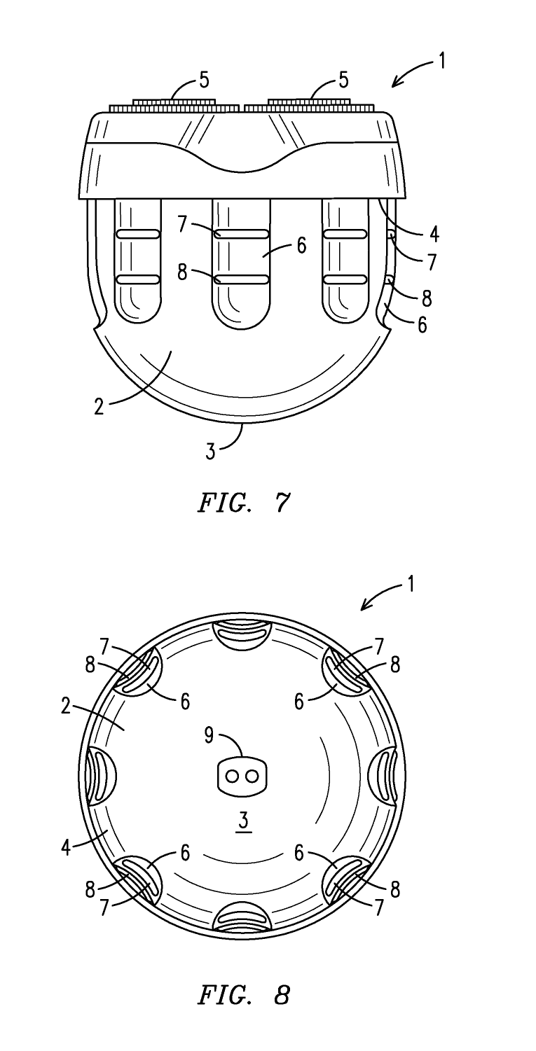

Now referring to FIGS. 7 and 8, a side view and a bottom view, respectively, of the electric head shaver with ergonomic handle of the present invention are shown, in which the handle is substantially round. The ergonomic handle 2 is substantially rounded so that it rests directly in a user's hand. One or more grooves 6 are located around the ergonomic handle 2.

A user may place his fingers in the grooves 6 to obtain a firm grip on the ergonomic handle and thus have greater control of the electric shaver. A gripping means 7, such as rubber strips 8, are located on the ergonomic handle 2 to prevent the ergonomic handle from slipping out of a user's hand. An electrical socket 9 is preferably located on the proximal end 3 of the ergonomic handle 2. The electrical socket 9 may be used in conjunction with an electric cord or a charging base to power the electric shaver 1.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

1. An electric head shaver for shaving a user's head comprising:
a shortened handle having a proximal end, a distal end, a front surface, a rear surface, a first side surface and a second side surface;
said shortened handle having a length substantially equal to the average length of a user's index finger, thereby allowing the user to place the proximal end against a palm of the user's hand while gripping the distal end with the user's fingertips;
said shortened handle being curved from the proximal end to the distal end toward the front surface to conform a palm and fingers of a user's hand;
at least one rear finger groove located on the rear surface of the handle;
a first side finger groove located on the first side of the handle;
a second side finger groove located on the first side of the handle;
at least one electric blade located on the distal end of the handle; and
an electrical socket located on the handle for providing power to the at least one electric blade.

2. The electric head shaver of claim 1 wherein:
said at least one rear finger groove located on the handle located on the rear surface of the handle comprises two rear finger grooves running parallel to the length of the handle.

3. The electric head shaver of claim 1 wherein:
said first side finger groove is angled around the first side toward the front surface and the distal end; and
said second side finger groove is angled around the first side toward the front surface and the distal end.

4. The electric head shaver of claim 1 further comprising:
at least one gripping means located on the handle.

5. The electric head shaver of claim 4 wherein:
said at least one gripping means is a rubber strip.

6. The electric head shaver of claim 1 wherein:
said length is within a range of 1 inch to 4 inches.

7. An electric head shaver for shaving a user's head comprising:
a shortened handle having a proximal end, a distal end, a front surface, a rear surface, a first side surface and a second side surface;
said shortened handle having a length that allows a user to place the proximal end against a palm of the user's hand while gripping the distal end with the user's fingertips;
said shortened handle being curved from the proximal end to the distal end toward the front surface to conform a palm and fingers of a user's hand;
at least one rear finger groove located on the rear surface of the handle;
a first side finger groove located on the first side of the handle;
a second side finger groove located on the first side of the handle;
said first side finger groove is angled around the first side toward the front surface and the distal end;
said second side finger groove is angled around the first side toward the front surface and the distal end;
at least one electric blade located on the distal end of the handle;
an electrical socket located on the handle for providing power to the at least one electric blade.

8. The electric head shaver of claim 7 further comprising:
at least on gripping means located on the handle.

9. The electric head shaver of claim 8 wherein:
said at least on gripping means is a rubber strip.

10. The electric head shaver of claim 7 wherein:
said at least one rear finger groove located on the handle located on the rear surface of the handle comprises two rear finger groove running parallel to the length of the handle.

11. The electric head shaver of claim 7 wherein:
said length is within a range of 1 inch to 4 inches.

12. An electric head shaver for shaving a user's head comprising:
a shortened handle having a proximal end, a distal end, a front surface, a rear surface, a first side surface and a second side surface;
said shortened handle having a length that allows a user to place the distal end against a palm of the user's hand while gripping the proximal end with the user's fingertips;
said shortened handle being curved from the proximal end to the distal end toward the front surface to conform to a palm and fingers of a user's hand;
two rear finger grooves located on the rear surface of the handle and running parallel to the length of the handle;
a first side finger groove located on the first side of the handle;
a second side finger groove located on the first side of the handle;
said first side finger groove is angled around the first side toward the front surface and the distal end;
said second side finger groove is angled around the first side toward the front surface and the distal end;
at least one electric blade located on the distal end of the handle; and
an electrical socket located on the handle for providing power to the at least one electric blade.

13. The electric head shaver of claim 12 further comprising:
at least one gripping means located on the handle.

14. (canceled)

15. The electric head shaver of claim 12 wherein:
said length is within a range of 1 inch to 4 inches.

16. The electric head shaver of claim 13 wherein:
said at least on gripping means is a rubber strip.
